(19) United States
(12) Patent Application Publication
(10) Pub. No.: US 2015/0181009 A1
(43) Pub. Date: Jun. 25, 2015

(54) PORTABLE TERMINAL DEVICE ACCESSORY

(71) Applicant: YUUGEN KAISYA KIKUGAWA KOUGYOU, Simonoseki-shi, Yamaguchi (JP)

(72) Inventor: Yasuaki Nakabayashi, Shimonoseki-shi (JP)

(21) Appl. No.: 14/412,210

(22) PCT Filed: Aug. 29, 2013
(86) PCT No.: PCT/JP2013/073110

§ 371 Date: Dec. 31, 2014

(30) Foreign Application Priority Data
Aug. 30, 2012 (JP) 2012-189936

(51) Int. Cl. H04M 1/04

(52) U.S. Cl. CPC H04M 1/04

(57) ABSTRACT

A conventional portable terminal device stand has a size equal to or larger than the size of a portable terminal device and is not considered to be carried together with the portable terminal device as a portable terminal device accessory, and therefore lacks portability. In the present invention, a portable terminal device accessory includes an engaging section which is provided on a top surface side and engages with one corner section of a portable terminal device and makes the portable terminal device stand; and a placement area expanding section which is provided on a bottom surface side and expands a placement area, wherein the top surface side and the bottom surface side have a predetermined space.

### TECHNICAL FIELD

The present invention relates to portable terminal device accessory in a flat plate shape (tablet shape) having a function of allowing moving images to be viewed and which includes a touch panel function on a display section.

### BACKGROUND ART

Specific examples of a portable terminal device in a flat plate shape having a function of allowing moving images to be viewed and which includes a touch panel function on a display section are a smartphone (multifunctional portable telephone) as one with a telephone function, and a tablet-type media player (multifunctional portable terminals) as one type of personal computer. However, these often have various functions redundantly provided as desired by users, and it is often difficult to clearly classify these only depending on the presence or absence of a function.

Thus, functions and features required for a portable terminal device targeted for the portable terminal device accessory of the present invention are recited and described. As required functions and features, such a portable terminal device includes a battery (rechargeable battery) incorporated therein, whereby portability is achieved; a housing the size of which is reduced and the shape of which is a flat plate shape (tablet shape) in order to improve portability; a display section which is arranged on a flat plate, that is, the largest surface of the housing, and the occupancy rate of which is as large as possible in order to improve viewability by collectively displaying information for ease of viewing; a touch panel function which is arranged on this display section and a function of receiving terrestrial digital broadcast such as one segment to be received by portable devices and/or replaying downloaded information of moving images such as movie and music; and a function of being capable of temporarily or continuously connecting to an accessory, such as a strap attachment hole.

When the portable terminal device is used to view the above-described moving images and the like, it is often the case that, once an initial operation is performed on the portable terminal device, additional operation is not required. In such a case, a user sometimes desires to view the moving images displayed on the portable terminal device with the portable terminal device placed on an appropriate place such as on a desk or table without using hands rather than holding the portable terminal device with a hand throughout continuous viewing. Since the portable terminal device is in a flat plate shape, when the portable terminal device is merely placed on a top plate of the desk or table, a user needs to peer into the portable terminal device because of poor viewability, thereby desiring to place the portable terminal device so that the portable terminal device stands at an angle easy to view. To address such a desire, for example, there has been provided a portable terminal device stand described in Patent Document 1.

In addition to viewing moving images, even if reading newspaper articles formed of characters and drawings, product description such as pamphlets, novels and comics, and the like, it may be better to place the portable terminal device in a state where the portable terminal device stands on the desk or table for use without touching the device with hands. Examples of such cases include a case of performing cooking while checking a recipe on the portable terminal device and a case of referring to descriptions in a reference document while reading the reference document to prepare a document.

However, when using the touch panel function of the portable terminal device, it is more convenient for the user to perform an operation of the portable terminal device while holding the portable terminal device with one hand so as to concentrate on the operation. In addition, although the touch panel is normally operated with a fingertip, it is convenient to use a stylus pen for input to perform a fine operation or a composite operation.

### PRIOR ART DOCUMENT

### Patent Document

Patent Document 1: JP 08-307500
Patent Document 2: JP 31604013 (U)

### SUMMARY OF INVENTION

### Problem to be Solved by the Invention

However, a conventional portable terminal device stand as described in Patent Document 1 has a size equal to or larger than the size of the portable terminal device, and is not supposed to be carried together with the portable terminal device as a portable terminal device accessory and therefore lacks portability.

As functions and features required for a portable terminal device accessory, such a portable terminal device accessory includes a structure capable of being carried integrally with the portable terminal device, such as a structure capable of being attached to a string of a strap and a structure capable of being connected to the portable terminal device by a terminal formed in a connector shape such as an earphone jack. Additionally, to be carried integrally with the portable terminal device, it is considered that the accessory is required to have a shape considerably smaller compared with the outer shape of the portable terminal device, have an aesthetic appearance suitable for an accessory, and has uniformity in the entire shape when the size of the accessory is decreased in minimal so as to make the accessory convenient to carry.

Furthermore, Patent Document 2 describes an example of a stylus pen for use as a portable terminal device accessory. However, this stylus pen as a portable terminal device accessory cannot be used as a portable terminal device stand.

### Means for Solving the Problem

In order to solve the above-described problem, the present invention takes the following technical measures.

A portable terminal device accessory of a first aspect comprises an engaging means which is provided on a top surface side and engages with one corner section of a portable terminal device and makes the portable terminal device stand; and a placement area expanding means which is provided on a bottom surface side and expands a placement area, wherein the top surface side and the bottom surface side have a predetermined space.

In the portable terminal device accessory of a second aspect according to the first aspect, an input means of a touch panel for the portable terminal device as a touch panel input means with a plurality of projections is provided between the top surface side and the bottom surface side.

In the portable terminal device accessory of a third aspect according to the second aspect, the plurality of projections have different tip shapes, respectively.

In the portable terminal device accessory of a fourth aspect according to the first aspect, an electrical connecting member electrically connectable to at least the portable terminal device and also connectable to another device is accommodated in the predetermined space formed by the top surface side and the bottom surface side, and the electrical connecting member is provided with a connection terminal to be connected to a connection port provided outside of the portable terminal device.

### Effect of the Invention

With the provision of the above-described technical measures, the present invention has the following effects.

According to the first aspect, the accessory comprises an engaging means which is provided on a top surface side and engages with one corner section of a portable terminal device and makes the portable terminal device stand; and a placement area expanding means which is provided on a bottom surface side and expands a placement area, wherein the top surface side and the bottom surface side have a predetermined space. Therefore, the accessory is in a compact state and considerably smaller than the portable terminal device, and can be carried together with the portable terminal device. Also, when the accessory is placed on a desk, table, or the like, the accessory can be used as a portable terminal device stand capable of widening the placement area and stably holding the portable terminal device.

According to the second aspect, in addition to the effects of the first aspect, an input means of a touch panel for the portable terminal device having a touch panel input means of a plurality of projections is provided between the top surface side and the bottom surface side. Therefore, a space between the top surface side and the bottom surface side required when the accessory is used as a stand can be effectively used. When the portable terminal device is used while being held with a hand, the function as a stand is not required, and the accessory can be used as a touch panel input means.

According to the third aspect, in addition to the effects of the second aspect, the plurality of projections have different tip shapes, respectively. Therefore, in the touch panel input means, the size of the tip at the time of input onto the touch panel and the effect at the time of input can be changed.

According to the fourth aspect, in addition to the effects of the first aspect, an electrical connecting member electrically connectable to at least the portable terminal device and also connectable to another device is accommodated in the predetermined space formed by the top surface side and the bottom surface side, and the electrical connecting member is provided with a connection terminal to be connected to a connection port provided outside of the portable terminal device. Therefore, the electrical connecting member can be always carried for use in the portable terminal device and also in other devices such as a personal computer, camera, and audio device that can be used in common. Thus, convenience can be improved.

### BRIEF DESCRIPTION OF DRAWINGS

FIG. 1 is an exploded view of a portable terminal device accessory of a first embodiment according to the present invention.

FIGS. 2(a) and (b) are use state descriptive views of the portable terminal device accessory of the first embodiment according to the present invention; and FIG. 2(a) is a use state descriptive view when carried, and FIG. 2(b) is a use state descriptive view when an input section of an input section touch panel is pulled out.

FIGS. 3(a) and (b) are descriptive views when a portable terminal device is mounted on the portable terminal device accessory of the first embodiment according to the present invention; and FIG. 3(a) is a descriptive view with the portable terminal device to be used in portrait orientation; and FIG. 3(b) is a descriptive view with the portable terminal device to be used in landscape orientation.

FIG. 4 is a side view for describing an engaging relation between the portable terminal, device accessory of the first embodiment according to the present invention and the portable terminal device.

FIGS. 5(a), (b) and (c) are use state descriptive views of a portable terminal device accessory of a second embodiment according to the present invention; and FIG. 5 (a) is a use state descriptive view when carried, and FIG. 5(b) is a use state descriptive view when a placement area expanding plate is pulled out; and FIG. 5(c) is a use state descriptive view when a touch panel input section is pulled out.

FIG. 6 is an outer view of a portable terminal device accessory of a third embodiment according to a third embodiment.

FIG. 7 depicts an outer view of the state where a bottom plate (section) of the portable terminal device accessory of the third embodiment according to the third embodiment is spread.

### DESCRIPTION OF EMBODIMENTS

Embodiments of the present invention will be specifically described based on the drawings.

### First Embodiment

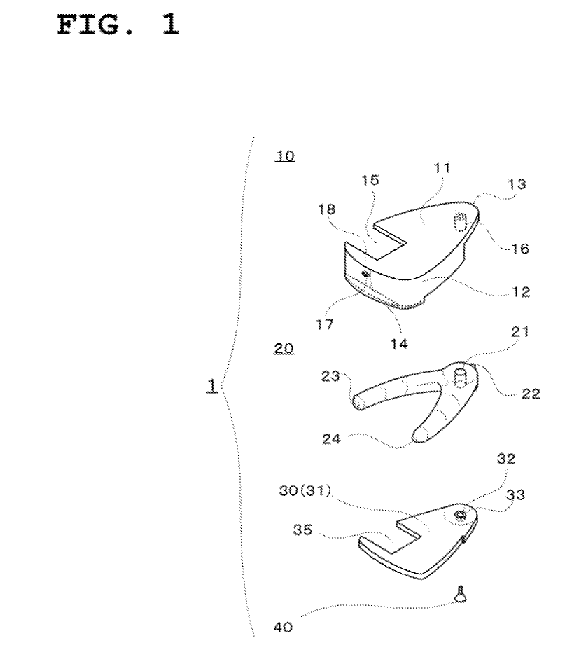

The structure of a portable terminal device accessory of the present invention (hereinafter simply referred to as an accessory 1) will be described using an exploded view of the accessory 1 depicted in FIG. 1. The accessory 1 is structured of a top plate section 10, an input section 20, a bottom plate section 30 and a screw 40 connecting these sections, from above in FIG. 1. The accessory 1 has an appropriate size depending on the size of a portable terminal device.

The top plate section 10 is structured of a top plate 11 and a side plate 12 extending downward from a portion of the periphery of the top plate 11, and is molded by using hard synthetic resin such as ABS resin or polypropylene resin. The top plate 11 has a sharpish rounded end 13 at one end and a gently rounded end 14 at an end opposite to the sharpish rounded end 13, and is formed in an acorn-like shape formed of a smooth curve as a whole. The width of the top plate 11 is increased from the sharpish rounded end 13 toward the mildly rounded end 14, and is provided with a notch 15 in an inverted-C shape on one side near the mildly rounded end 14. On an inner surface of the top plate 11 near the sharpish rounded end 13, a female screw projection 16 in a cylindrical shape is provided downward, with a female screw hole provided at the tip.

The side plate 12 is provided as a continuous hanging wall on a mildly rounded end 14 side and a portion a side not provided with the notch 15. On an outer surface of the side plate 12 on a mildly rounded end 14 side, a string projection 17 is provided to which a string as a strap is attached. Also, on an inner surface side of a portion corresponding to the notch 15 on a mildly rounded end 14 side of the side plate 12, a vertical abutting surface 18 connecting to the notch 15 is provided.

The input section 20 has a substantially Y shape with three projections, and has a predetermined thickness, and is molded by using a material to which conductivity is provided by adding conductive powder to flexible and restorable synthetic rubber or soft synthetic resin. At a substantially center portion of a portion from which the projections of the input section 20 project in three directions, a hole 21 is provided, with a hole diameter adjusted such that the input section 20 can be moved when appropriated force is added in a state where the female screw projection 16 is inserted into that hole 21. The three projections forming a substantially Y shape have tips molded as an medium input end 22 in a hemispheric shape with a radius of approximately 3 millimeters, a large input end 23 in a hemispheric shape with a radius of approximately 5 millimeters, and a small input end 24 in a hemispheric shape with a radius of approximately 1.5 millimeters.

The bottom plate section 30 is structured of a bottom plate 31 in a substantially flat plate shape. The bottom plate 31 has a shape substantially analogous to that of the top plate 11 in an acorn shape, is provided with a notch 35 with a size similar to the notch of the top plate 11 at a position corresponding to the top plate 11, is molded by using hard synthetic resin such as ABS resin or polypropylene resin. The bottom plate 31 is provided with a screw hole 32 at a position corresponding to the female screw projection 16 of the top plate section 10. Around the screw hole 32, a recess 33 is provided to fit an outer peripheral circle of the female screw projection 16. The reason for providing the recess 33 is that the recess 33 facilitates positioning of the bottom plate section 30 to the top plate section 10 and assembly of the accessory 1.

Assembly of the accessory 1 is completed by inserting the female screw projection 16 of the top plate section 10 into the hole 21 of the input section 20, accommodating the input section 20 in the top plate section 10, assembling the female screw projection 16 to the recess 33 of the bottom plate section 30, and then screwing the screw 40, which penetrates through the screw hole 32 of the bottom plate section 30, into the female screw projection 16. In consideration of the accessory 1 as an ornament, the screw 40 is a countersunk screw so that the head of the screw 40 does not protrude outside of the bottom plate 31, and a recess corresponding to the countersunk screw is also provided on an outer surface of the bottom plate 31.

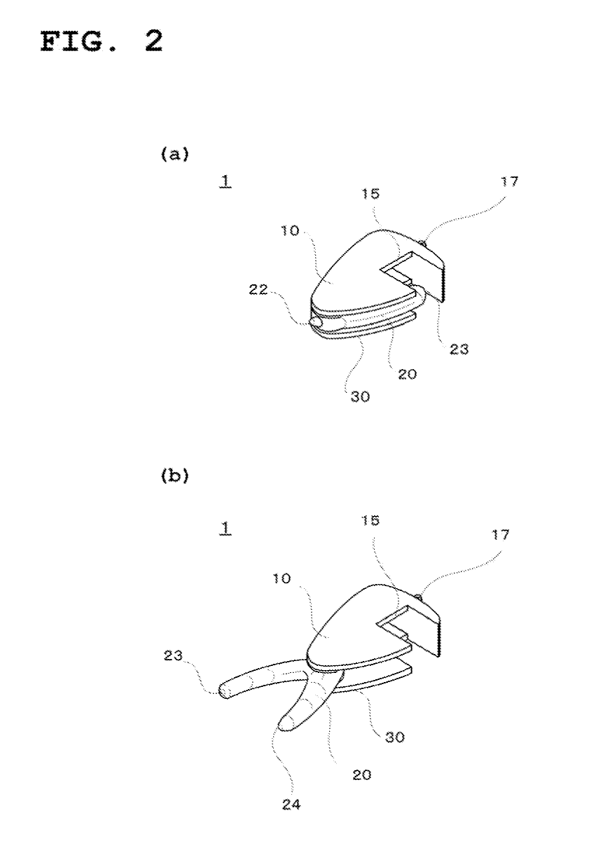

FIG. 2(a) depicts a state after the accessory 1 is assembled. In this state, the large input end 23 and the small input end 24 of the input section 20 are accommodated inside the accessory 1, and the accessory 1 can have a compact shape suitable for being carried together with the portable terminal device. Since the medium input end 22 of the input section 20 protrudes outside even in this state, the accessory 1 as a whole can be used as a stylus pen for the portable terminal device by being held outside.

Next, FIG. 2 (b) depicts a state where the large input end 23 and the small input end 24 of the input section 20 are taken out to the outside of the accessory 1. In order to change the state of FIG. 2(a) to the state of FIG. 2(b), a finger is put into the notch 15 in FIG. 2 (a) to be hooked in the large input end 23, and the input section 20 is rotated toward a front direction with the female screw projection 16 as an axis, whereby the accessory 1 is in the state of FIG. 2(b). This is why the side plate 12 is not provided on the side provided with the notch 15 of the top plate section 10.

In the state of FIG. 2(b), by holding the outside of the accessory 1, both of the large input end 23 and the small input end 24 can be used, whereby two locations on the touch panel of the portable terminal device can be simultaneously operated. Also, an enlarging operation and a reducing operation of a screen of the portable terminal device can be performed with ease. Furthermore, since the angle of the input section 20 with respect to the top plate section 10 can be changed, it is possible to use either one of the large input end 23 and the small input end 24 as a stylus pen. Still further, since the large input end 23, the small input end 24, and the medium input end 22 respectively have different shapes, it is possible to input with a different writing feeling for characters, pictures, or the like by using any of these ends as a stylus pen for the touch panel.

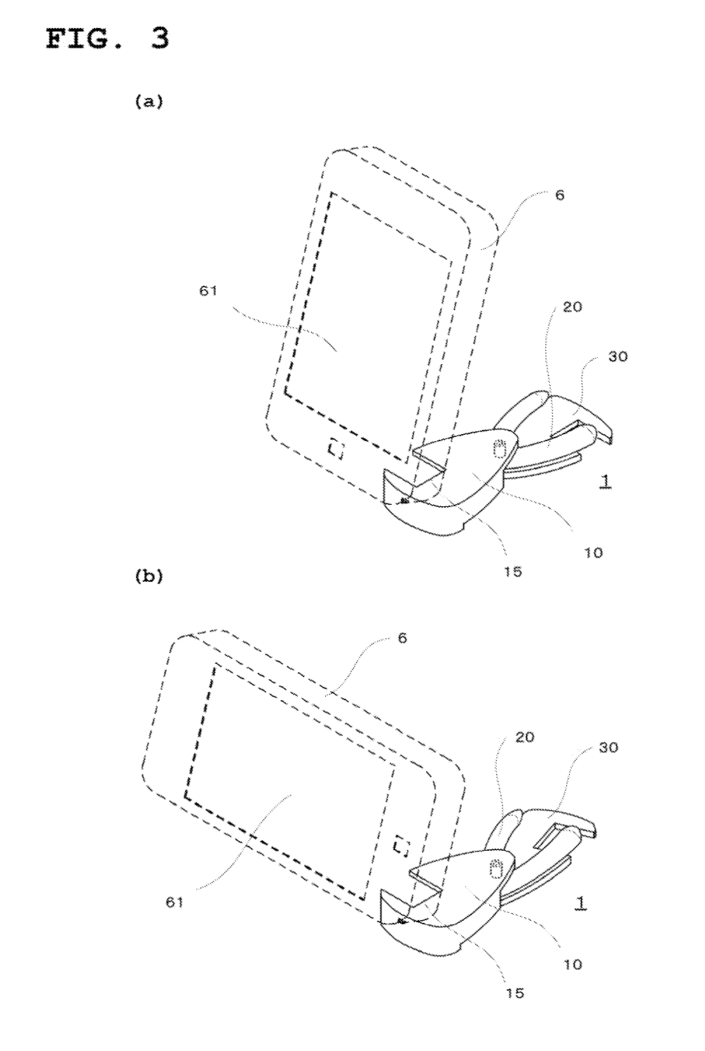

FIGS. 3(a) and (b) are diagrams for describing a case where the accessory 1 is used as a stand for a portable terminal device 6. FIG. 3(a) is a diagram when, in a state where the portable terminal device 6 (shown by a broken line) is placed in portrait orientation, the portable terminal device is engaged in the accessory 1 and is leaned against the accessory 1. FIG. 3(b) is a diagram when, in a state where the portable terminal device 6 is placed in landscape orientation, the portable terminal device is engaged in the accessory 1 and is leaned against the accessory 1. The portable terminal device 6 in FIGS. 3(a) and (b) can be leaned by the accessory 1 such that a screen 61 of the portable terminal device 6 is oriented slightly upward.

In both of FIGS. 3(a) and (b), the accessory 1 is used in a state where the input section 20 and the bottom plate section 30 are taken out to the outside of the top plate section 10 from the inside of the top plate section 10 by rotating the input section 20 and the bottom plate section 30, with the female screw projection 16 as an axis. Note that it is not necessary to take the input section 20 to the outside when the large input end 23 of the input section 20 is the length, not projecting from the notch 15.

By rotating and spreading the bottom plate section 30 in a direction away from the notch 15 of the accessory 1, the point of supporting the portable terminal device 6 can be placed away from the portable terminal device 6, whereby the state of the portable terminal device 6 leaned is stabilized. Also, by changing the angle of rotation of the bottom plate section 30, the point of supporting the portable terminal device 6 can be changed farthest from the portable terminal device 6, whereby the state of stabilization of the portable terminal device 6 can be adjusted according to the portrait or landscape state of the portable terminal device 6. Note that, as depicted in FIG. 2(b), the portable terminal device 6 can be leaned even when the bottom plate section 30 is not taken out to the outside of the top plate section 10 and only the input section 20 is taken out to the outside of the top plate section 10. However, the state of the portable terminal device 6 is more stabilized when the bottom plate section 30 is taken out to the outside of the top plate section 10.

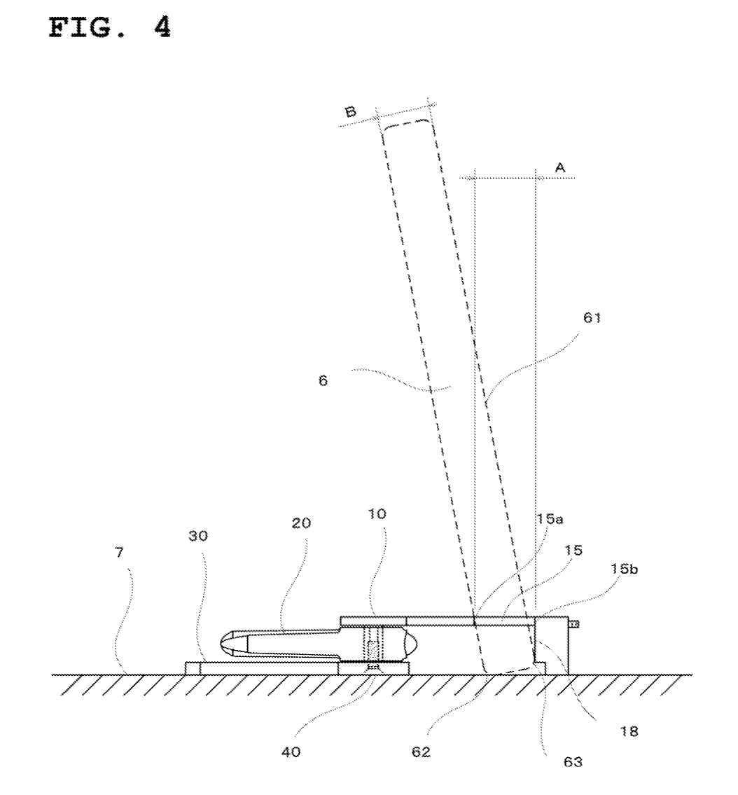

In FIGS. 3(a) and (b), one corner of the portable terminal device 6 is inserted into the notch 15 of the top plate 11, whereby the portable terminal device 6 is leaned. An engaging relation between the accessory 1 and the portable terminal device 6 will be described in detail using FIG. 4.

FIG. 4 is a side view of the notch 15 of the top plate section 10 of the accessory 1 when viewed from an opening side. The accessory 1 is placed on a flat surface 7 such as a desk or table, in a state where the input section 20 and the bottom plate section 30 are taken out to the outside of the accessory 1. An opening width A of the notch 15 has a predetermined margin larger than a thickness B of the portable terminal device 6 (shown by a broken line), and is adjusted so that the portable terminal device 6 can be leaned at an inclination which does not cause the portable terminal device 6 to be unstabilized. For example, when the portable terminal device 6 is a smartphone, the thickness B is normally on the order of 8 millimeters to 12 millimeters, and therefore the opening width A is thought to be 12 millimeters to 16 millimeters. When the portable terminal device 6 is leaned in this manner, the screen 61 of the portable terminal device 6 is oriented in a slightly upward direction, and therefore can be viewed with ease.

When the portable terminal device 6 enters the inside of the notch 15 in a state where a lower portion 62 of the portable terminal device 6 is in contact with the flat surface 7, the portable terminal device 6 comes in contact with a left end 15a of the notch 15 and a corner 63 of the portable terminal device 6 comes in contact with a contact surface 18 extending from a right end 15b of the notch 15, whereby the portable terminal device 6 keeps a standing state at a predetermined angle without falling down.

Thus, regarding a space between a top surface side and a bottom surface side of the accessory 1, a predetermined space is required between the left end 15a and a point where the corner 63 of the portable terminal device 6 comes in contact with the contact surface 18. Basically, regarding the space between the top surface side and the bottom surface side, the space between the top surface side and the bottom surface side is required to be widened as the roundness of the corner 63 of the portable terminal device 6 increases. In order to narrow the space between the top surface side and the bottom surface side, the shape of the contact surface 18 may be changed. For example, in order to prevent the corner 63 of the portable terminal device 6 from easily slipping, the surface of the contact surface 18 is processed into a rough state, a material such as a rubber sheet or coarse fabric on which large friction force acts is attached, or a recess in which the corner 63 fits is provided to the contact surface 18. However, to stably keep the standing state of the portable terminal device 6, a space to some extent is required between the top surface side and the bottom surface side because the corner 63 of the portable terminal device 6 has a smooth, round shape.

As described above, the top plate section 10 on the top surface side of the accessory 1 is provided with an engaging means which engages with one corner section of the portable terminal, device 6 and makes the portable terminal device 6 stand, and the bottom plate section 30 on the bottom surface side of the accessory 1 is provided with a placement area expanding means which expands a placement area.

### Second Embodiment

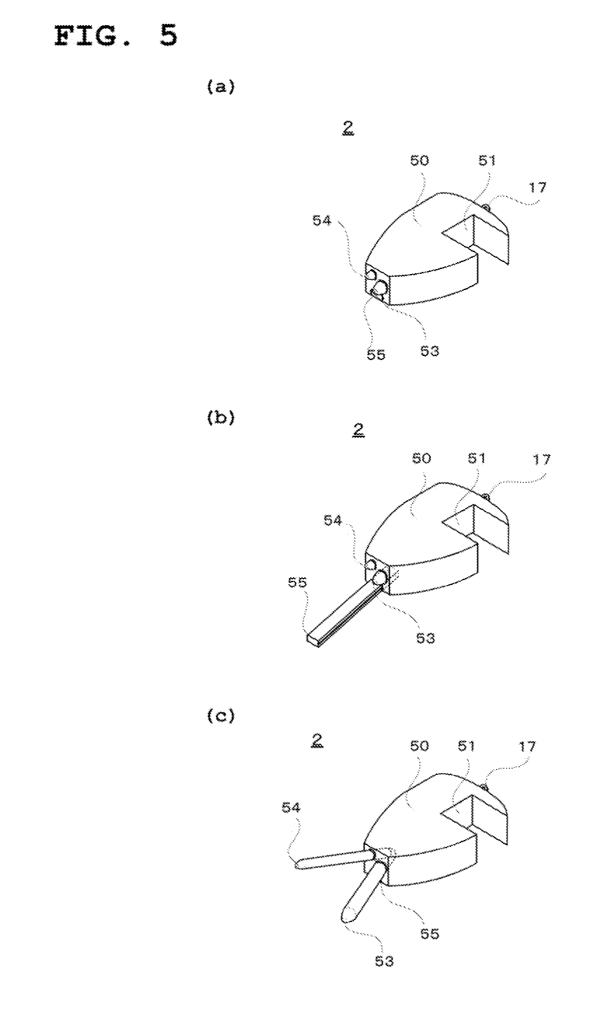

An accessory 2 of the present invention will be described using FIG. 5. The accessory 2 of a second embodiment is significantly different from the accessory 1 of the first embodiment in a point that, while the mechanism of the placement area expanding section and the touch panel input section of the accessory 1 of the first embodiment is of a rotation type, the mechanism of the placement area expanding section and the touch panel input section of the accessory 2 of the second embodiment is of a slide type. Other than this different point, the state of engaging with the portable terminal device described with reference to FIG. 3 and FIG. 4 is basically the same in the first and second embodiments, and is therefore not described herein.

FIG. 5(a) depicts an outer appearance of the accessory 2. FIG. 5(a) depicts the shape where the accessory 2 is made compact so as to be suitable for being carried together with the portable terminal device, and the outer appearance is similar to that of the accessory 1 in the state of FIG. 2(a) in the first embodiment. The accessory 2 is formed by that a string projection 17 is attached to a housing 50 constituting a great portion of the accessory 2. The housing 50 is provided with a notch 51 in an inverted-C shape near a side where the string projection 17 is attached to the housing 50. Also, at an end opposite to the side where the string projection 17 is attached, a large input end 53, a small input end 54, and a placement area expanding plate 55 are accommodated in the housing 50, with only their tips exposed outside.

The housing 50 is molded by using hard synthetic resin such as ABS resin or polypropylene resin. Depending on the processing method, the housing 50 can be formed by respectively molding two, three or more portions into which the housing 50 is divided and then bonding or screwing the two, three, or more portions together.

FIG. 5(b) is a diagram depicting a state where the placement area expanding plate 55 is pulled out of the housing 50 by being slid. By pulling out the placement area expanding plate 55 provided on the bottom surface side of the accessory 2 in a direction away from the notch 51, the portable terminal device can be supported at a position away from the portable terminal device, and therefore the portable terminal device can stably stand. The placement area expanding plate 55 is a rectangular plate with a uniform width. On a side surface in contact with the housing 50, a convex to avoid falling from the housing 50 is provided, and fits in a concave on a housing 50 side. Also, at an end of the placement area expanding plate 55 on a side most deeply entering the inside of the housing 50, an anti-dropping mechanism for preventing from being completely pulled out of the housing 50 is provided.

FIG. 5(c) is a diagram depicting a state where the large input end 53 and the small input end 54 are pulled out of the housing 50. By holding the outside of the accessory 2, both of the large input end 53 and the small input end 54 can be used, whereby two locations on the touch panel of the portable terminal device can be simultaneously operated. Also, an enlarging operation on the screen of the portable terminal device can be performed with ease. Furthermore, since only either one of the large input end 53 and the small, input end 54 can be pulled out, it is possible to use either one of the large input end 53 and the small input end 54 as a stylus pen. Still further, since the large input end 53 and the small input end 54 respectively have different shapes, it is possible to input with a different writing feeling as a stylus pen.

A shaft portion which supports each of the large input end 53 and the small input end 54 is formed by molding a material into a cylindrical shape, the material to which conductivity is provided by adding conductive powder to flexible and restorable synthetic rubber or soft synthetic resin, and includes a mechanism of sliding inside of the cylinder provided inside of the housing 50. Also, at an end of the shaft continuing to each of the large input end 53 and the small input end 54 on a side most deeply entering the inside of the housing 50, an anti-dropping mechanism for preventing from being completely pulled out of the housing 50 is provided.

Still further, at the end of the shaft continuing to each of the large input end 53 and the small input end 54 on the side most deeply entering the inside of the housing 50, a shaft fixing mechanism for preventing from being easily pushed back when used as a stylus pen is provided. As the anti-dropping mechanism and the shaft fixing mechanism, a method can be taken, for example, such that, since the material of the shaft continuing to each of the large input end 53 and the small input end 54 has flexibility and restorability, the shaft diameter of the end of the shaft continuing to each of the large input end 53 and the small input end 54 on the side most deeply entering the inside of the housing 50 is gradually increased toward the end.

### Third Embodiment

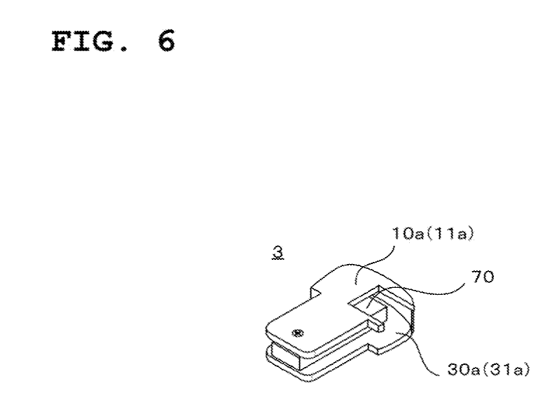

An accessory 3 of the present invention will be described using FIG. 6.

The accessory 3 of a third embodiment is significantly different from the accessory 1 of the first embodiment in a point that, while the input section 20 is accommodated in a space between the top plate 11 of the top plate section 10 and the bottom plate 31 of the bottom plate section 30 of the accessory 1 of the first embodiment, that is, between the top plate 11 on a top surface side and the bottom plate 31 on a bottom surface side, an electrical component 70, which is electrically connectable, is accommodated in a space between a top plate 11a of a top plate section 10a on a top surface side and a bottom plate 31a of a bottom plate section 30a on a bottom surface side of the accessory 3 of the third embodiment. Also, while the outer appearance of the accessory 1 is a substantially acorn shape, the outer appearance of the accessory 3 formed of the top plate section 10a and the bottom plate section 30a is a substantially T shape.

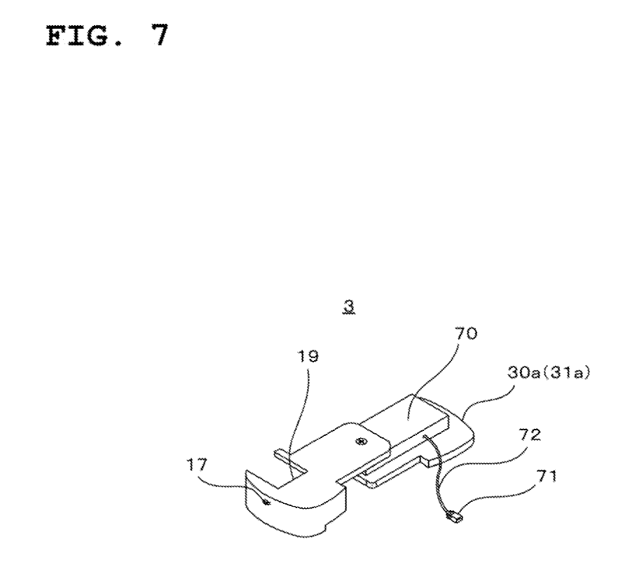

FIG. 7 is a diagram depicting a state where the bottom plate 31a of the bottom plate section 30a is rotated to be spread in a direction away from a notch 19 of the accessory 3 and the electrical component 70 is also simultaneously rotated in a manner similar to that of the bottom plate 31a. With the state of FIG. 7, the portable terminal device 6 can be leaned with a notch 19 provided to the top plate 11a. Other than the electrical component 70 accommodated in the accessory 3 and the outer appearance of the accessory 3, the state of engaging with the portable terminal device 6 in the third embodiment is basically the same as that described in FIG. 3 and FIG. 4 in the first embodiment, and therefore is not described herein.

The electrical component 70 accommodated in the accessory 3 is a connecting member electrically connectable to the portable terminal device 6. Therefore, examples of the electrical component 70 include a rechargeable battery with a connection terminal 71 such as a USB plug connectable to a connection port 8 such as a USB socket (female) as an external interface included in the portable terminal, device 6; a recharger with a power generating means such as a solar panel; a memory as an external storage device; and a wireless communication device which can transmit and receive information to and from a wireless communication means such as a wireless LAN or portable telephone. Also, when the connection port 8 of the external interface is an acoustic socket (female), the electrical component 70 can be an earphone, loudspeaker, or the like including a connection terminal 71 for a acoustic plug connectable to the acoustic socket (female). Any of these rechargeable battery, recharger, external storage device, earphone, loudspeaker, and the like can be used not only for the portable terminal device 6 but for other devices, such as a personal computer, camera and audio device, which have the connection port 8 that supports the connection terminal 71 and complies with connection-permitted specifications.

Depending on the purpose of use of the electronic component 70, methods of connecting the electrical component 70 and the connection terminal 71 include a method in which the connection terminal 71 is provided directly on an outer surface of the electrical component 70 in a manner to be exposed therefrom and a method in which an electrical wire (cord or cable) 72 with a predetermined length is connected to the electrical component 70 to be connected to the connection terminal 71 as depicted in FIG. 6. It is possible that the electrical wire 72 is also used as a string as a strap of the accessory 3. When the electrical wire 72 is also used as a string as a strap, the string projection 17 provided as well as in the first embodiment is not provided, and the electrical wire 72 is engaged at an appropriate position on a side plate 12a of the accessory 3 and is taken out.

In the predetermined space between the top plate section 10 as a top surface side and the bottom plate section 30 as a bottom surface side, the following can be accommodated, although the size and the like are restricted:

cosmetics such as lipstick, Lotion, and perfume accommodated in a container, and cosmetic tools such as mirrors and combs;

stationery such as a small measuring tape, writing tools, scissors, stamps, and seals;

industrial tools such as a screwdriver, wrench, and knife;

flashlight, pointer, key chain, and security buzzer;

cleaning tools such as cloth, paper, sponge to wipe out soils on the display section or the casing of the portable terminal device, and a liquid cleaner accommodated in a container for use in cleaning the portable terminal device 6; and

other goods that are convenient when carried together with the portable terminal device.

The present application is based on Japanese Patent Application No. 2012-189936 filed in Japan by the applicant on Aug. 30, 2012, the entire contents of which are incorporated herein by reference.

While the present invention has been described based on the embodiments, the present invention is not limited to any of the structures of these embodiments. For example, the shape of each of the accessory 1, accessory 2 and accessory 3 is not limited to a substantially acorn shape or a substantially T shape, but can be any of various shapes such as a circle, triangle, quadrangle, trapezoid, and heart shape for implementation. Also, while the shape and size of the tip of the input section have been described as an example, more appropriate ones are selected depending on the relation with the portable terminal device. The materials described above are also described as an example, and another material can be used for implementation as long as required functions are satisfied.

The description of the specific embodiments of the present invention have been suggested for the purpose of exemplification, and are not intended to be exhaustive or limit the present invention to the embodiments described herein themselves, it is evident for a person skilled in the art that various modifications and changes could be made in view of the above description.

### INDUSTRIAL APPLICABILITY

The portable terminal device accessory of the present invention can be carried together with the portable terminal device. When the accessory is placed on a desk or table, the placing area is widened, and the accessory can be used as a portable terminal device stand capable of stably holding the portable terminal device. Therefore, the present invention is useful in industry.

### DESCRIPTION OF REFERENCE NUMERALS

1, 2, 3: accessory
6: portable terminal device
7: flat surface
8: connection port
10, 10a: top plate section
11, 11a: top plate
12, 12a: side plate
13: sharpish rounded end
14: mildly rounded end
15, 19, 35, 51: notch
15a: left end
15b: right end
16: female screw projection
17: string projection
18: abutting surface
20: input section
21: hole
22: medium input end
23, 53: large input end
24, 54: small input end
30, 30a: bottom plate section
31, 31a: bottom plate
32: screw hole
33: recess
40: screw
50: housing
55: placement area expanding plate
61: screen
62: lower portion
63: corner
70: electrical component
71: connection terminal
72: electrical wire

1. A portable terminal device accessory comprising:
an engaging section which is provided on a top surface side and engages with one corner section of a portable terminal device and makes the portable terminal device stand; and
a placement area expanding section which is provided on a bottom surface side and expands a placement area by being rotated or slid,
wherein the top surface side and the bottom surface side have a predetermined space.

2. The portable terminal device accessory according to claim 1,
wherein an input section of a touch panel for the portable terminal device as a touch panel input section with a plurality of projections is provided between the top surface side and the bottom surface side.

3. The portable terminal device accessory according to claim 2,
wherein the plurality of projections have different tip shapes, respectively.

4. The portable terminal device accessory according to claim 1,
wherein an electrical connecting member electrically connectable to at least the portable terminal device and also connectable to another device is accommodated in the predetermined space formed by the top surface side and the bottom surface side, and the electrical connecting member is provided with a connection terminal to be connected to a connection port provided outside of the portable terminal device.
